(19) United States
(12) Patent Application Publication
(10) Pub. No.: US 2006/0065837 A1
(43) Pub. Date: Mar. 30, 2006

(54) Tomographic reconstruction of transmission data in nuclear medicine studies from an array of line sources

(76) Inventor: Eric G. Hawman, Schaumburg, IL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/235,480

(22) Filed: Sep. 26, 2005

Related U.S. Application Data
(60) Provisional application No. 60/612,748, filed on Sep. 24, 2004.

(51) Int. Cl. G01T 1/166

(52) U.S. Cl. 250/363.04; 378/4

(57) ABSTRACT

Attenuation correction in SPECT studies such as cardiac function imaging is carried out using an iterative statistically-based transmission projection reconstruction algorithm that is capable of modeling overlapping transmission beams from a line source array of radiation emitters. Downscatter between emission and transmission photons is additively corrected for in the algorithm. Optimal line source spacing techniques and source collimation angle selection are derived to improve performance and reduce cost.

### BACKGROUND

### Field of the Invention

The present invention relates generally to nuclear medical imaging devices and more particularly relates to Single Photon Emission Computed Tomography (SPECT) nuclear medicine studies and correction of data attenuation in such studies.

Introduction:

In various environments, such as in medical environments, imaging devices can include detectors that detect electromagnetic radiation emitted from radioactive isotopes or the like within a patient. The detectors typically include a sheet of scintillation crystal material that interacts with gamma rays emitted by the isotope to produce photons in the visible light spectrum known as “events.” The scintillation camera includes one or more photodetectors such as an array of photomultiplier tubes, which detect the intensity and location of the events and accumulate this data to acquire clinically significant images that are rendered on a computer display for analysis.

In a conventional SPECT study of an organ such as the heart, a radioisotope (Tc-99m, TI-201, for example) is administered to the patient and the radioisotope is taken up by the heart muscles. Then, the patient is placed in an imaging bed of a scintillation camera system and one or more scintillation camera detectors are rotated about the long axis of the patient and interact with gamma emissions from the patient's body at various angular orientations about the axis. The resulting data is used to form three-dimensional images (known as “SPECT images” or “tomographic images”) of the distribution of the radioisotope within the patient.

Such three-dimensional SPECT images can be calculated based on a set of two-dimensional images (“projections” or “projection images”) acquired by the scintillation camera system as the detectors are rotated about the patient in a series of steps; this calculation process is known as image reconstruction. The most commonly employed method of image reconstruction is known as filtered back-projection or FBP. When FBP reconstruction is used to reconstruct SPECT images from two-dimensional projection images obtained from a scintillation camera, some well-recognized distortions introduce errors or artifacts in the result. One of the most critical distortions is caused by attenuation of gamma radiation in tissue.

As a consequence of attenuation, quantitative image values in the various projections do not accurately represent line integrals of the radioisotope distribution within the body. It is therefore necessary to correct for this distortion, and the process for doing so in SPECT is known as attenuation correction.

Many prior art techniques for attenuation correction in SPECT have assumed that the linear attenuation coefficient of the body is uniform and impose such uniformity as a mathematical constraint in the image reconstruction process. However, for a very important class of studies, namely cardiac SPECT studies, the linear attenuation coefficient of the body is in fact highly non-uniform. This is because lung tissue has a lower attenuation than do, e.g., the blood and other non-lung tissue. Further, linear attenuation coefficients may be different for different areas of the body having varying mass, density, etc.

Thus, in SPECT studies of, e.g., the heart, a SPECT reconstruction of the image of radioactivity within the heart will necessarily contain artifacts caused by the unequal attenuation coefficients of, e.g., the lungs and other parts of the body.

It is known to measure the actual attenuation coefficients of body tissues by placing a line source of gamma radiation on one side of the body and measuring the transmission of the gamma radiation through the body as a function of direction, i.e. collecting transmission CT data, as the line source is scanned across the patient's body. See, e.g. U.S. Pat. No. 5,576,545 (Stoub et al.) incorporated herein by reference in its entirety.

However, present methods suffer from certain disadvantages. In particular, FBP does not optimally process the noise or distortion in the projection data. FBP is not statistically based, and the conventional FBP computational algorithm is prone to “streak” artifacts predominantly oriented in the radial direction. The streak artifact significantly degrades the attenuation correction of SPECT images reconstructed from attenuation maps (“μ-maps”) with FBP.

Another problem with existing attenuation correction methods involves the correction of transmission CT data for downscatter by subtracting estimated downscatter values from the transmission data. Attenuation of the transmission radiation beam through a patient can be large (˜50), resulting in count-starved data. Subtraction from this data of estimated downscatter obtained from an adjacent energy comparison window can result in a measurement of zero or even non-physically possible “negative” values. Consequently, use of FBP for transmission reconstruction requires either truncation of downscatter-corrected transmission data to avoid negative values, or use of some other ad-hoc process to fill data “holes.”

Some SPECT systems such as PROFILE™ (SIEMENS™) estimate downscatter from the counts in a region of interest (ROI) in the field of view (FOV) not covered by the transmission sources. For example, in FIG. 4, the downscatter fraction f is

$$f = \frac{C ( R , {S}_{1} )}{R , {S}_{2}} ,$$

and then the μ-transmission (ρ_{μ}) is calculated as

$${p}_{μ} = log [ ( \frac{{t}_{p}}{{t}_{B}} ) [ \frac{smooth ( B - {B}_{s2} * f )}{smooth ( T - {T}_{s2} * f )} * decayfactor ] ] .$$

The reason for using an extra-cardiac ROI for estimation of downscatter is to avoid an extra scan to make the measurement over the heart region; however, in cardiac imaging, the stomach, bowels, liver or other organs below the heart often have higher activity than the heart. For example, in myocardial studies using sestimidi, there is often very high radioisotope uptake in the liver, stomach and bowel but not in the heart. Therefore, the scatter in this region is not the same as that in the heart region, and using a sub-cardiac region for estimation of the downscatter fraction can seriously bias the estimate, causing errors in the attenuation map (i.e., mu-map).

Thus, while a variety of methods and apparatus are known as described above, there remains a need in the art for improved methods and apparatus overcoming the above and/or other problems.

### SUMMARY OF THE INVENTION

The preferred embodiments of the present invention can significantly improve upon existing methods and/or apparatus. According to a preferred embodiment of one aspect of the invention, a new type of algorithm for μ-map reconstruction uses a statistically-based estimation of the μ-map. Such algorithm allows overlapping of line source radiation patterns at the detector, and additive inclusion of emission-to-transmission downscatter.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by a way of example and not limitation in the accompanying figures, in which:

FIG. 1 is a schematic view of an attenuation correction system including a line source of transmission radiation for attenuation correction in accordance with the methods and apparatus of the present invention;

FIG. 2 is a generalized schematic drawing of a two-dimensional line source radiation array which can be used with the system of FIG. 1;

FIG. 3 is an example of spatial orientation of an array of line sources of radiation in accordance with the methods and apparatus of the present invention; and

FIG. 4 is a diagram showing a current method for estimation of downscatter crosstalk.

### DETAILED DESCRIPTION OF THE PREFERRED EMBODIMENTS

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

Summary of Attenuation Correction Procedure and Set-Up

Before explaining the various aspects and preferred embodiments of the present invention, a brief explanation will be given of a conventional procedure for obtaining transmission CT data for attenuation correction in SPECT studies. In a SPECT study, a collimated detector is rotated to a plurality of consecutive angularly separated stationary positions around a patient. Typically, for a conventional (180°) cardiac SPECT study, the detector will be rotated to 60 stationary positions or stations, each spaced 3° from the stations adjacent to it. The detector typically is kept at each station for on the order of 25 seconds while acquiring emission data using the desired radioisotope (typically, Tc-99m or TI-201).

If the SPECT study is to be corrected for attenuation, transmission CT data must be acquired at each station. Conventionally, this is done by using a line source made of a different radioisotope (such as Gd-153) and acquiring, at each station, emission and transmission CT data simultaneously. This in turn is done by using two distinct energy windows, each corresponding to one of the radioisotopes.

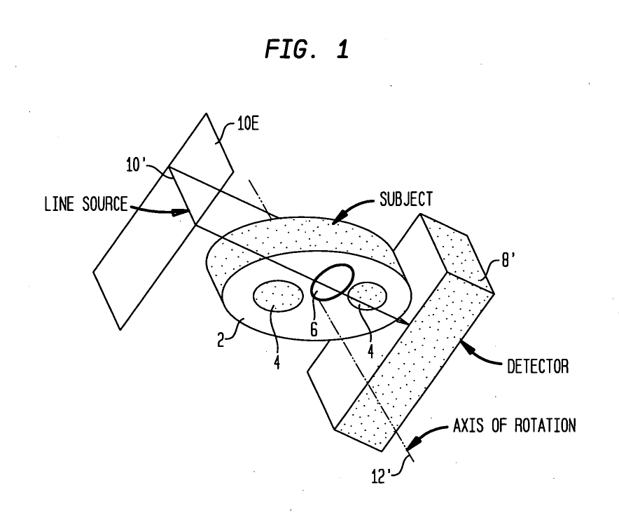

Referring to FIG. 1, transmission CT data is acquired using a line source array 10, which is oriented parallel to the axis of rotation 12 of the detector with which it is associated. A subject patient 2 has two lungs 4 and a heart 6. To carry out an attenuation-corrected SPECT cardiac study, the patient is interposed between the collimated detector 8 of a scintillation camera system (not otherwise shown) and the line source 10. The line source array 10 is parallel to the axis 12 about which the detector 8 rotates, and emits radiation such that the detector acquires transmission CT data from the patient 2 over a region 10E transversely across the patient 2, i.e. from the patient's left side to the right side, or vice versa. This prevents the ends of the line source array 10 from producing “hot spots” on the detector 8 where no attenuation of radiation by the patient has occurred and thus which would require the radiation density of the line source array to be restricted to prevent overwhelming of the detection system.

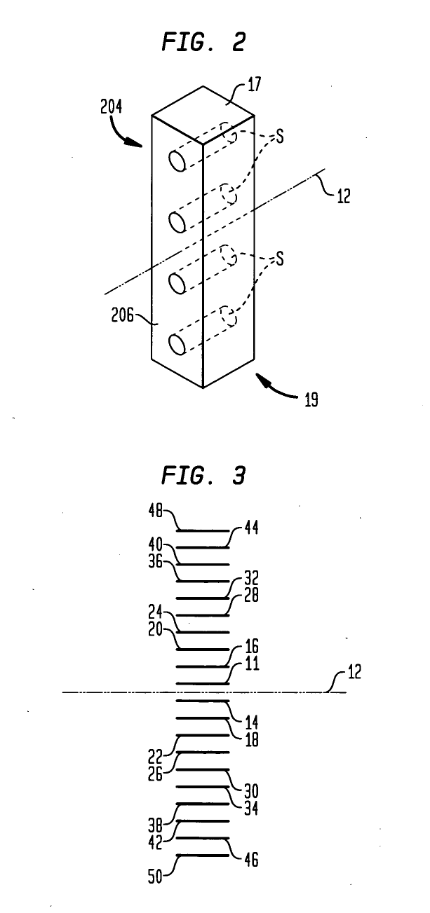

Referring to FIG. 2, a known line source array radiation emitter 204 is shown. The array 204 is oriented with respect to the axis of rotation 12 of the detector as indicated. The emitter 204 has an elongated frame 206 with ends 17 and 18, into which frame 206 twenty Gd-153 line sources S may be removably placed. When the line sources S are placed in the frame 206, the line sources S form a twenty-location array (see FIG. 3) that is centered on the axis 12. As shown, the array is a simple series of parallel lines spaced at regular intervals between the ends 17 and 18. The locations of the array are shown by reference numerals 11, 14, 16, 18, 20, 22, 24, 26, 28, 30, 32, 34, 36, 38, 40, 42, 44, 46, 48 and 50; these locations are parallel to the axis 12 (and may, if desired, be coplanar). In the preferred embodiment, each of the line sources S is approximately six inches long and each of the locations 11 . . . 50 is spaced one inch away from its neighbors, producing an emitter 204 that is approximately six inches wide and twenty inches long.

As can be seen in FIG. 3, the pair of line sources S at positions 11 and 14 is at the center of the array and is centered on the axis 12. Another pair of line sources S at positions 16 and 18 is adjacent to the pair of line sources S at positions 12 and 14 respectively and is likewise centered; similarly centered line source pairs extend outwardly from the center of the array to the line source pair that includes the line sources S at positions 48 and 50. As a result, there are ten pairs of line sources S, each pair including two line sources S that are equidistant from the center of the array.

Line sources S in each pair have approximately the same activity (quantity of radioactive material, expressed in mCi, therefore producing the same radiation density) but the activity changes progressively from one pair to the next in equal fractional steps. Since Gd-153 has a half-life of eight months, four months of radioactive decay causes any particular Gd-153 line source to lose approximately 30% of its activity (i.e. approximately 30% of the Gd-153 decays to another isotope during this period of time). Advantageously, and in accordance with the preferred embodiment, with each outward step, each pair of line sources S has an activity diminished by 30% from the immediately preceding pair.

Maximum-Likelihood Estimation Algorithm

According to the present invention, a reconstruction algorithm based on maximum-likelihood estimation is provided for the case where a transmission source is a line source array such as shown in FIG. 2. The reconstruction algorithm preferably is implemented as a computer-implemented procedure encoded in computer-executable program instructions, however any other implementation mechanism as would be acceptable is contemplated by the invention and is intended to be encompassed within the meaning of “computer-implemented.”

The radiation patterns received from the line sources may overlap at the detector, and downscatter (emission-to-transmission) is additively taken into account in the projection estimation. Consequently, the prior art problem of zero or physically-impossible negative transmission projection data is avoided.

The transmission flux data Tp is modeled as:

$$Tp = P oisson [ {\sum }_{m} {B}_{pm} exp ( - {\sum }_{j} {μ}_{j} {l}_{jpm} ) + {S}_{p } ] \qquad ( 1 )$$

where Bₚₘ is line intensity;
Sₚ is scatter;
μⱼ is the linear attenuation coefficient for pixel j;
   and ιⱼₚₙ is the quadrature weight associated with the contribution by pixel j to the transmission over the path from m to p, where m is a line source location and p is a data point on the detector on which transmission photon impinges.

By maximizing the logarithmic likelihood function:

$$l n L = {\sum }_{p} ( - {\overline{T}}_{p} + {T}_{p} l n {\overline{T}}_{p} ) \qquad ( 2 )$$

with respect to μⱼ, where \overline{T}ₚ is the expected value of Tp, it is possible to obtain an iterative equation for μⱼ (and hence the p-map):

$${μ}_{j}^{n + 1} = {μ}_{j}^{n} \frac{{\sum }_{p} {\sum }_{m} {B}_{pm} exp ( - {\sum }_{j} {μ}_{j} {l}_{jpm} ) {l}_{jpm}}{{\sum }_{p} \frac{{T}_{p}}{{\overline{T}}_{p}} {\sum }_{m} {B}_{pm} exp ( - {\sum }_{j} {μ}_{j} {l}_{jpm} ) {l}_{jpm}} \qquad ( 3 )$$

Use of this reconstruction algorithm instead of FBP gives a ρ-map reconstruction with higher spatial resolution, lower image noise, and therefore much better image quality.
Downscatter Estimation Method

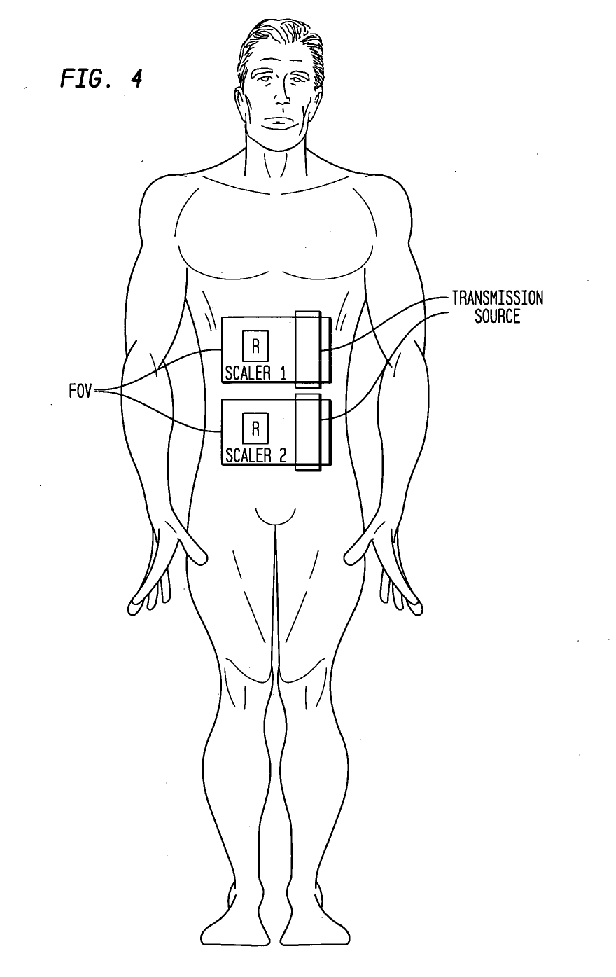

The existing downscatter estimation method for eliminating downscatter crosstalk estimates downscatter from counts in an extra-cardio region of interest (ROI) in the field of view (FOV) not covered by the transmission sources, as shown in FIG. 4. For cardiac imaging, when organs below the heart such as the stomach, liver or bowels have a high activity level relative to the heart, the estimate of downscatter fraction can be in substantial error. The reason for using an extra-cardio ROI for downscatter estimation is to avoid the additional scan that would be required to make the measurement over the heart region.

According to another aspect of the present invention, projection data from the heart region can be acquired during the pre-scan used to determine the non-circular orbit (NCO) of the detector, i.e. with the transmission source off. The pre-scan projection data then can be analyzed to estimate the downscatter fraction in the heart. This downscatter fraction estimate is then used as the scatter value Sₚ in Equation (1) above.

The invention having been thus described, it will be obvious to those skilled in the art that the same may be varied in many ways without departing from the spirit and scope of the invention. Any and all such modifications are intended to be included within the scope of the following claims.

What is claimed is:

1. A method of reconstructing transmission data from an array of line sources for attenuation correction in nuclear medicine studies, comprising the steps of
a. acquiring projections of said transmission data from said array of line sources;
b. reconstructing said transmission data using a μ-map obtained from the following algorithm
$${μ}_{j}^{n = 1} = {μ}_{j}^{n} \frac{{\sum }_{p} {\sum }_{m} {B}_{pm} exp ( - {\sum }_{j} {μ}_{j} {l}_{jpm} ) {l}_{jpm}}{{\sum }_{p} \frac{{T}_{p}}{{\overline{T}}_{p}} {\sum }_{m} {B}_{pm} exp ( - {\sum }_{j} {μ}_{j} {l}_{jpm} ) {l}_{jpm}}$$
where
p denotes a data element,
m denotes a line number,
j denotes a reconstruction pixel,
Tₚ denotes a transmitted flux line,
\overline{T}ₚ denotes an expected value of Tₚ,
Bₚₘ denotes line intensity,
Sₚ denotes scatter,
μⱼ denotes a linear attenuation coefficient for pixel j, and
Iⱼₚₘ denotes the quadrature weight associated with a contribution by pixel j to a transmission over a path from m to p.

2. A method of estimating downscatter in SPECT comprising the steps of
a. acquiring a first transmission data of an object while a transmission source is off,
b. acquiring a second transmission data of said object while said transmission source is on, and
c. comparing said first and second transmission data.

3. The method of claim 2, wherein said first and second transmission data are acquired during a scan of said object.

4. The method of claim 2, wherein said first and second transmission data are acquired at a same view.

5. A method of estimating downscatter in SPECT comprising the steps of
a. acquiring a first transmission data of an object while a transmission source is off during a pre-scan over said object to determine a contouring orbit for a camera,
b. acquiring a second transmission data of an object while said transmission source is on during a scan over said object, and
c. comparing said first and second transmission data.

6. An image reconstructing apparatus comprising
a. means for acquiring transmission data of an object, and
b. means for processing said transmission data using a μ-map obtained from the following algorithm:
$${μ}_{j}^{n = 1} = {μ}_{j}^{n} \frac{{\sum }_{p} {\sum }_{m} {B}_{pm} exp ( - {\sum }_{j} {μ}_{j} {l}_{jpm} ) {l}_{jpm}}{{\sum }_{p} \frac{{T}_{p}}{{\overline{T}}_{p}} {\sum }_{m} {B}_{pm} exp ( - {\sum }_{j} {μ}_{j} {l}_{jpm} ) {l}_{jpm}}$$
wherein
p denotes a data element,
m denotes a line number,
j denotes a reconstruction pixel,
Tₚ denotes a transmitted flux line,
\overline{T}ₚ denotes an expected value of Tₚ,
Bₚₘ denotes line intensity,
Sₚ denotes scatter,
μⱼ denotes a linear attenuation coefficient for pixel j, and
Iⱼₚₘ denotes the quadrature weight associated with a contribution by pixel j to a transmission over a path from m to p.

7. An image reconstructing apparatus comprising
a. means for acquiring a first transmission data of an object while a transmission source is off,
b. means for acquiring a second transmission data of an object while a transmission source is on, and
c. means for comparing said first and second transmission data.
